(19) United States
(12) Patent Application Publication
(10) Pub. No.: US 2003/0150874 A1
(43) Pub. Date: Aug. 14, 2003

(54) Nozzle for disseminating active substances

(76) Inventor: Marc Meire, Frechen (DE)

Correspondence Address: Aslan Baghdadi, Shaw Pittman, 1650 Tysons Boulevard, McLean, VA, 22102, US

(21) Appl. No.: 10/239,567

(22) PCT Filed: Mar. 22, 2001
(86) PCT No.: PCT/DE01/01104

(30) Foreign Application Priority Data
Mar. 24, 2000 (DE) 100 14 339.3
Jul. 12, 2000 (DE) 100 33 917.4

(51) Int. Cl. B67D 5/00

(52) U.S. Cl. 222/83

(57) ABSTRACT

A nozzle for dissemination of active substances comprising a nozzle head that has an outlet opening for the active substance; and a nozzle casing that is fitted with a port for an air pipe. The nozzle is characterized by the fact that the nozzle casing is an elongated tube that can accommodate an active substance cartridge and that at one end region of said tube the port for the air pipe is fitted and characterized by the fact that the nozzle head, at least partially, can be inserted into the opposite end region of the tube in a detachable manner whereby the nozzle head has the same dimensions as the tube in an axial direction; and by the fact that in the installation the active substance cartridge is held in place against the nozzle head and that the nozzle head is fitted with a flow channel that extends from the outlet opening to the active substance cartridge. The invention also relates to a system that feeds active substances into a room employing said nozzle.

The present invention relates to a nozzle for dissemination of active substances comprising a nozzle head that is fitted with an outlet opening for the active substance; and a nozzle casing that is fitted with a port for an air pipe.

Scents are often used at sales presentations. Systems for scenting rooms also are known; even vehicles are now scented to provide the driver with a pleasant atmosphere.

Continuous scenting is possible but occasionally it is desirable that dissemination of the scent occurs on demand.

U.S. Pat. No. 6,004,516 A describes a device for generating a scent on the demand of an electronic signal. A disk holds an absorbent material that has been impregnated with an aroma. The disk is inserted into an appropriate disk drive that receives signals from a user or also from a server. A controller within the disk drive delivers an electric, mechanical or thermal signal to the disk resulting in the scent carrier being heated which then resultis in the scent being released. A fan could aid in the distribution of the scent.

The scent storage medium is always critical in such scent distribution mechanisms. Firstly, it must be able to contain sufficient scent or other active substance to prevent the storage medium from becoming empty too quickly. There is a risk of destroying or at least interfering with the scent or active substance when thermally activating them.

DE 197 53 956 A1 describes an active substance cartridge through which a carrier gas flows. This can occur up to 1,000 times without resulting in a noticeable decline in the amount of scent or active substance released during each flow through. Additionally, a substrate made from porous particles of silica gel, activated carbon and/or aluminum oxide which have been impregnated with scents or active substances is stored and fixed in a small cylindrical glass or aluminum tube.

The small tube is closed with caps each of which are fitted with a membrane disk that can be perforated by needles or cannulae enabling the release of scents or active substances. Such scent or active substance cartridges are still in use.

It is the object of the present invention to improve a nozzle, of the type described above, in such a way that the active substance that is stored in cartridges easily can flow through and be released. The type of active substance cartridge used should not be limited to the type described in DE 197 53 956 A1.

Furthermore, it is the object of the invention to make available a system for supplying active substances into a room employing said nozzle.

The object of the invention is realized with said nozzle by designing the nozzle casing as an elongated tube that can accommodate an active substance cartridge and at one end of said tube the port for the air pipe is fitted. Furthermore, the nozzle head is inserted, at least partially, into the opposite end region of the tube in a detachable manner, whereby the nozzle head has the same dimensions as the tube in an axial direction. The active substance cartridge is held in place against the nozzle head in the installation and the nozzle head is fitted with a flow channel that extends from the outlet opening to the active substance cartridge.

In accordance with the invention the active substance cartridge is held firmly in one place in the nozzle in such a way that the air that enters the nozzle from the air pipe readily flows through it. The simplest embodiment for such an active substance cartridge would consist of a small tube that is open at both ends whereby the small tube is sealed before use. The installation according to the invention prevents tilting and the cartridge can easily be replaced when it is empty by removing the nozzle head.

In a preferred embodiment of the invention, in the first end region of the tube is a first installation shoulder for the active substance cartridge that aids in controlling movement when the active substance cartridge is inserted.

Preferably, the active substance cartridge is spring loaded in the direction of the nozzle head. This is appropriately achieved by holding in place a coil spring that presses against the active substance cartridge in the first end region of the tube.

In the first end region of the tube an adaptor can be fitted to hold a hollow needle that is used as the flow channel whereby one end of the hollow needle reaches into the active substance cartridge and the other end communicates with the port. In this manner, the air that is employed as the carrier gas is led directly to the active substance. This best mode is particularly advantageous when employing an active substance cartridge that is initially closed with a membrane. This is because when the active substance cartridge is inserted the hollow needle will perforate the membrane thereby enabling air to flow through it. As is well known, the hollow needle could have either a slanted or sharp end.

Preferably, in this embodiment in the first end region of the tube there is a second installation shoulder that holds the adaptor.

This embodiment can be used to hold the coil spring in place between the adaptor and the interior wall of the tube.

Correspondingly, the flow channel of the nozzle head can also be, at least partially, designed as a hollow needle that reaches into the active substance cartridge.

The flow channel in the interior of the nozzle head can, at least partially, run at an angle on the longitudinal axis of the nozzle head when necessary to facilitate the scenting or discharging of an active substance into a room. In such a case, it would be useful to optimize the nozzle head by providing it with a sufficient scent cone.

Both the geometrical execution of the transitional region and the length of the flow channel that is angled towards the outlet opening appear to be relevant factors. To assure that the straight running sections are sufficiently long it is preferable that the section of the nozzle head that is not immersed in the tube has a dome-like shape.

The easy removal of the nozzle head and the replacement of the active substance cartridge are achieved when the nozzle head is held in place relative to the tube by a bayonet fastener or two screws.

The system according to the invention that feeds active substances into a room uses the nozzle in conjunction with a pump or a compressor to discharge the active substance cartridge that is located in the nozzle case whereby the pump or the compressor switches on or off in response to a corresponding signal sent by a sensor.

Preferably, the sensor sends signals to an electronic connection that controls the operating flow of the pump or the compressor.

Particularly preferred, is a remote controlled electronic connection, for example, using a hand-held transmitter.

Sensors could be of the infrared, ultrasonic, ultra short wave, light or vibration type as well as of the sound responding or contact mat types.

The electronic connection can be configured in such a way that the active substance flow, or, as the case may be, the scent flow can be released with a pre-selected delay.

Below, the invention is described in greater detail in the enclosed figures. They show:

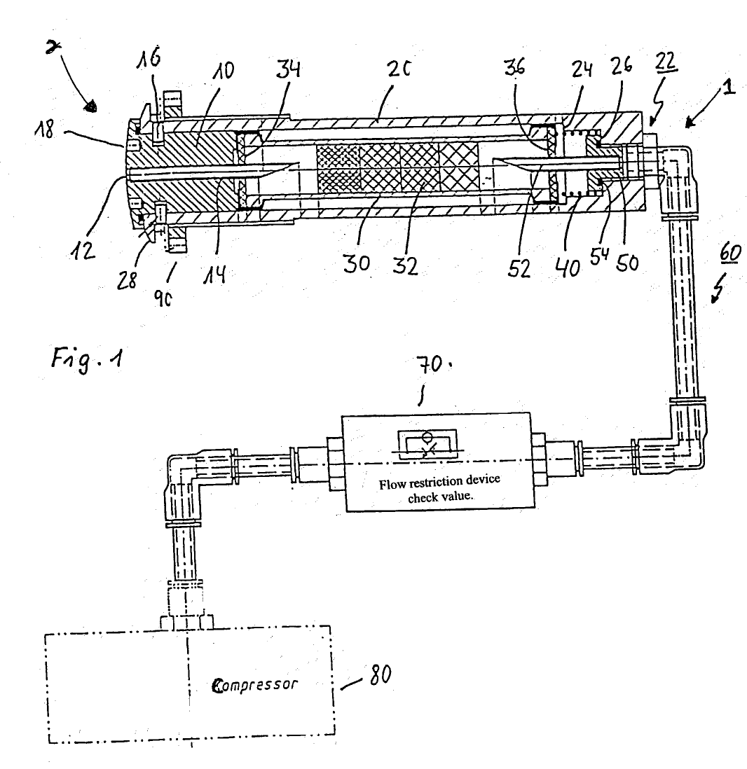

FIG. 1 a nozzle according to a first embodiment of the present invention fitted with an air system;

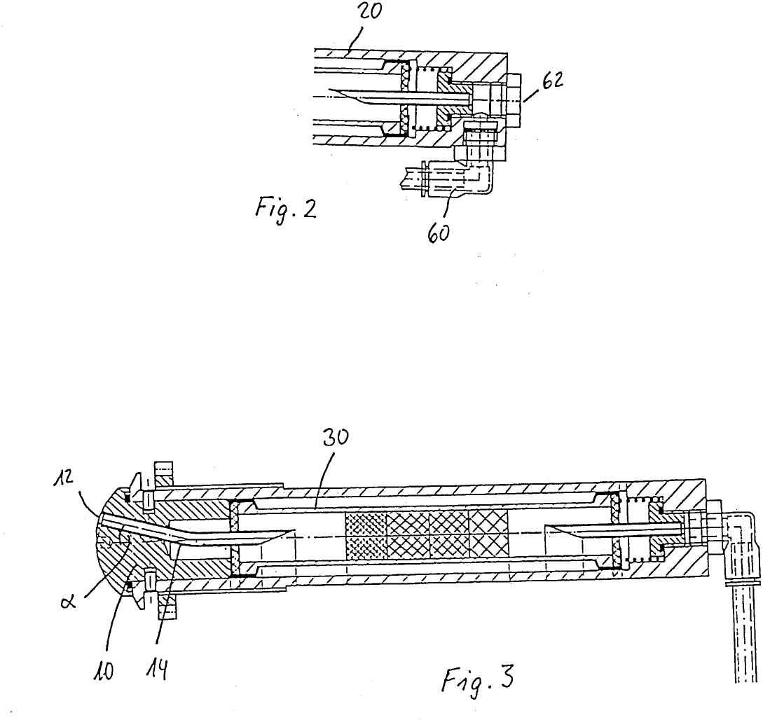

FIG. 2 a modification of the air supply port fitted to the nozzle;

FIG. 3 an additional nozzle embodiment according to the invention with modified nozzle head; and

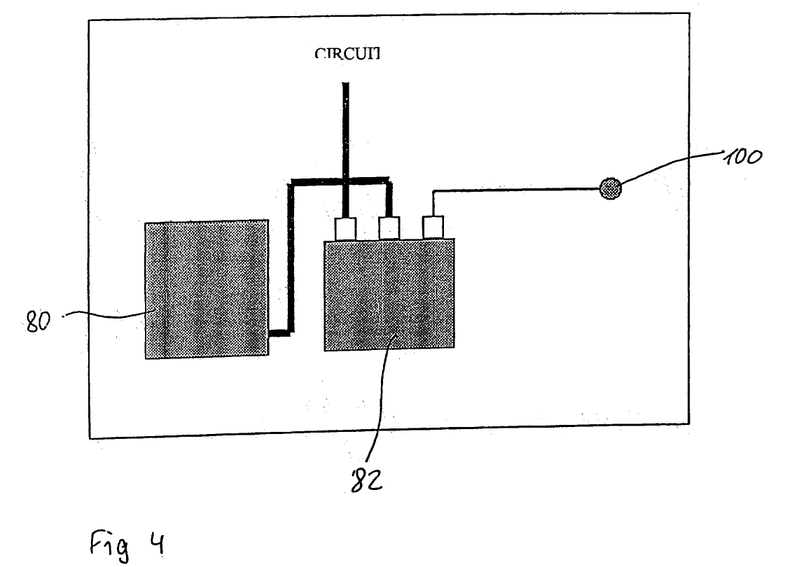

FIG. 4 a schematic representation of the air supply control system.

The nozzle represented in FIG. 1 is fitted with a nozzle head 10 that is partially embedded in an elongated tube 20 and is held in place there with a bayonet fastener 16 that is not described in greater detail. A hollow needle 14 is put through the nozzle head 10 and ends in an outlet opening 12. At the opposite end the hollow needle 14 reaches beyond the nozzle head 10 into an active substance cartridge 30 that is located in the tube 20. The nozzle head 10 is protected against inappropriate removal since a special key is needed for this purpose. This special key must catch two or more boreholes 18 located at the front of the nozzle head 10.

The interior diameter of the tube 20 is chosen so that the active substance cartridge 30 can be guided into it in a precise manner. The tube 20 is fitted with a port 22 for an air pipe 60 in the end region that lies across from the nozzle head 10. The port 22 embodiment is well known. It is mounted in the usual manner into a borehole in the tube 20. Above the port 22 is an adaptor 50 into which a hollow needle 52 is inserted. The head of the adaptor 50 rests on an installation shoulder 26 inside the tube 20 and is held against the installation shoulder 26 with a washer 54 to prevent air exchange between the interior of the tube 20 and the surroundings. The part of the adaptor 50 that rests on the installation shoulder 26 is proportioned in such a way that enough room remains between it and the interior wall of the tube 20 to allow a coil spring 40 to be inserted there. The coil spring 40 is thus held in place by the adaptor. The corresponding conically shaped interior wall increases the holding capacity further. This is not shown in the figure.

To initiate nozzle operation the nozzle head 10 is removed and an active substance cartridge 30 is inserted into the tube 20. The nozzle embodiment shown here is suitable for use with an active substance cartridge 30 that is closed at both ends each with a membrane 34 or 36. The tube is pushed in until the hollow needle 52 perforates the membrane 36. Then the active substance cartridge 30 is pushed further against the resistance offered by the coil spring 40 in the direction of the port 22 until it comes to rest on an installation shoulder 24 which is positioned somewhat away from the installation shoulder 26. Then the nozzle head 10 is inserted into the tube 20 by using the already described special key and is latched on with the help of the bayonet fastener 16. At this point, the hollow needle 14 perforates the membrane 34 in the active substance cartridge 30. After the membrane 34 has been perforated a rotation of, at most, 180° generally suffices to hold the nozzle head 10 in place relative to the tube without risking damage to the membrane 34. The nozzle is now ready for use.

The user or another signal source such as, for example, a remote control device, a mechanical push button or a motion detector via the Internet or a similar device can send a signal that activates a compressor 80 or, as the case may be, a pump. Preferably, a compressor 80 is selected that will have a long lifespan despite frequent short operation. For example, when a regular scent presentation is performed in, for example, a department store the operational time will be approximately 12 hours per day with approximately 60 operating time intervals per hour lasting 10 seconds maximum. A suitable compressor would thus have a lifespan of 3 years.

A flow restriction device and a check valve are placed between the compressor 80 and the nozzle. In the present embodiment they are integrated into a structural component 70 but single components are also possible. It is estimated that the flow restriction device controls between 8 and 12 liters of air flow per minute. The check valve prevents an air exchange from occurring between the nozzle and compressor 80 after the compressor 80 has been switched off.

When the compressor 80 has generated the necessary air supply it is able to flow through the air pipe 60 into the tube 20 and, in particular, through the hollow needle 52 into the active substance cartridge 30 where it will come into contact with the active substance that has been absorbed on a substrate 32. The active substance is released into the air flow, enters the hollow needle 14 and is released through the outlet opening 12.

To mount the nozzle assembly, for example, in an elevator or vehicle the tube 20 is fitted with a ring-mounting device 28 in the end region into which the nozzle head 10 is fitted. This ring-mounting device 28 will lie closely to the wall of the elevator or vehicle and the nozzle is then rear-mounted using a screw nut 90.

An alternative embodiment could consist of two screw nuts positioned apart from each other for holding the nozzle in place. The ring-mounting device 28 would then not be needed.

FIG. 2 shows a variation in which the air pipe 60 is connected to the tube 20 in a radial direction. Otherwise, the configuration corresponds to the installation shown in FIG. 1. The axial borehole for the air supply port as shown in FIG. 1 can be closed with a screw 62.

FIG. 3 shows a modification of the nozzle head 10. In this embodiment the outlet opening 12 no longer lies on the longitudinal axis of the nozzle head 10 but rather is offset from it. The flow channel 14 runs at a corresponding angle a on the longitudinal axis of the nozzle head 10 over a specific distance which must be optimized to suit the design of a scent or active substance cone. To achieve this, the hollow needle which functions as the flow channel 14 would be bent to enable it to finally run along the longitudinal axis and reach into the active substance cartridge 30. To implement this embodiment, it would be appropriate to design the nozzle head 10 to not be as solid in the area of the bend and the final straight running section as is the case for the implementation shown in FIG. 1 but rather to provide those segments with a hollow space that is surrounded by a cylinder-like segment 19 of the sleeve. The active substance cartridge 30 will thus lie next to the cylinder-like segment 19 of the sleeve.

The hollow needle 14 will appropriately be affixed to the nozzle head 10. The passage between the hollow needle 14 and the outlet opening 12 is smooth and without joints.

Efforts have been made to keep the total length of the nozzle according to the invention as short as possible. An optimal accessory is a mounting adaptor that would enable the mounting at a certain angle, for example, 30° and would save space by reducing the mounting depth.

Preferably, the tube 20 is made from a metallic material.

The invention can be employed for applications other than the ones mentioned above which all mainly relate to scents. The system using the nozzle according to the invention could also, for example, be used to improve the atmosphere of rooms that, for example, allergy sufferers occupy. During such use the cartridge would contain the appropriate active substances.

FIG. 4 shows a schematic representation of the control system for the air system. In the operation circuit of the compressor 80 or, as the case may be, the pump there is an electronic connection 82 that receives signals sent by a sensor 100. When the sensor 100 detects movement, proximity or contact it sends a signal to the electronic connection 82 which then connects the compressor 80 or the pump which will then release the flow of the active substance. In this manner the intervals between the individual releases and the duration of the active substance flow can be pre-determined. Sensors 100 could be of the infrared, ultrasonic, ultra short wave and light type. Also suitable are sensors that respond to sound or the human voice as well as sensors that respond to vibration. A contact mat that is spread out on the floor of the room in which the active substances are to be released can also be used as a sensor 100. All functions of the electronic connection 82 are programmed using a hand held sensor that is not shown. The electronic connection 82 can be designed in such a manner that that it will collect information about usage that can be retrieved by a laptop or personal computer for market research purposes.

The characteristics of the invention revealed in the above description, in the drawing, as well as in the patent claims could be significant for the realization of the invention individually as well as in any combination.

1. Nozzle for dissemination of active substances fitted with
a nozzle head (10) that is fitted with an outlet opening (12) for the active substance; and
a nozzle casing (20) that is fitted with a port (22) for the air pipe (60).
Characterized by the fact that
the nozzle casing is an elongated tube (20) enabling the accommodation of an active substance cartridge(30) and at one end region of said tube, the port (22) for the air pipe (60) is fitted and characterized by the fact that the nozzle head (10), at least partially, can be inserted into the opposite end region of the tube (20) in a detachable manner, whereby the nozzle head (10) has the same dimensions as the tube (20) in the axial direction; and by the fact that in the installation the active substance cartridge (30) is held in place against the nozzle head (10) and that the nozzle head (10) is fitted with a flow channel (14) that extends from the outlet opening (12) to the active substance cartridge (30).

2. Nozzle according to claim 1, characterized by the fact that in the first end region of the tube (20) is fitted a first installation shoulder (24) for the active substance cartridge (30).

3. Nozzle according to claim 1, characterized by the fact that the active substance cartridge (30) is spring-loaded in the direction of the nozzle head (10).

4. Nozzle according to claim 3, characterized by the fact that in the first end region of the tube (20) a coil spring (40) is held in place.

5. Nozzle according to claim 1, characterized by the fact that in the first end region of the tube (20) an adaptor (50) is fitted that holds in place a hollow needle (52) that functions as a flow channel whereby one end of the hollow needle (52) reaches into the active substance cartridge (30) and the opposite end communicates with the port (22).

6. Nozzle according to claim 5, characterized by the fact that in the first end region of the tube (20) a second installation shoulder (26) is fitted on which the adaptor (50) sits.

7. Nozzle according to one of claims 4 to 6, characterized by the fact that the coil spring (40) is held in place between the adaptor (50) and the interior wall of the tube (20).

8. Nozzle according to claim 1, characterized by the fact that the flow channel (12) of the nozzle head (10), at least partially, is designed as a hollow needle that reaches into the active substance cartridge (30).

9. Nozzle according to claim 8, characterized by the fact that the flow channel (12) inside the nozzle head (10), at least partially, runs at an angle (a) on the longitudinal axis of the nozzle head (10).

10. System for supplying active substances into a room using a nozzle according to one of claims 1 to 9, using a pump or a compressor to discharge the active substance cartridge that is located in the nozzle casing, characterized by the fact that the pump or the compressor (80) will switch on or off in response to a signal sent by a sensor (100).

11. System according to claim 10, characterized by the fact that the sensor sends the signals to an electronic connection (82) that controls the operating flow of the pump or the compressor (80).

12. System according to claim 11, characterized by the fact that the electronic connection (82) is remote controllable.

13. System according to one of claims 10 to 12, characterized by the fact that the sensor (100) is of the infrared, ultrasonic, ultra short wave, light, sound or vibration type.

14. System according to one of claims 11 to 13, characterized by the fact that the electronic connection (82) releases the active substance flow with a pre-selectable delay.
